(19) United States
(12) Patent Application Publication
(10) Pub. No.: US 2023/0220226 A1
(43) Pub. Date: Jul. 13, 2023

(54) WHITE INK, NON-WHITE INK, INK SET, PRINTING SET, PRINTING METHOD, AND PRINTING APPARATUS

(71) Applicants: Hiroki HAGIWARA, Kanagawa (JP); Tomohiro Nakagawa, Kanagawa (JP); Kazuhiko Umemura, Shizuoka (JP); Masayuki Koyano, Kanagawa (JP); Sei Yamamoto, Tokyo (JP); Yuya Hirokawa, Kanagawa (JP); Takuya Saiga, Kanagawa (JP)

(72) Inventors: Hiroki HAGIWARA, Kanagawa (JP); Tomohiro Nakagawa, Kanagawa (JP); Kazuhiko Umemura, Shizuoka (JP); Masayuki Koyano, Kanagawa (JP); Sei Yamamoto, Tokyo (JP); Yuya Hirokawa, Kanagawa (JP); Takuya Saiga, Kanagawa (JP)

(73) Assignee: Ricoh Company, Ltd., Tokyo (JP)

(21) Appl. No.: 17/998,256

(22) PCT Filed: Apr. 27, 2021
(86) PCT No.: PCT/IB2021/053434

§ 371 Date: Nov. 8, 2022

(30) Foreign Application Priority Data
May 27, 2020 (JP) 2020-092269
Jan. 8, 2021 (JP) 2021-001908

(51) Int. Cl. C09D 11/38; C09D 11/40; C09D 11/54

(52) U.S. Cl. CPC C09D 11/38; C09D 11/40; C09D 11/54

(57) ABSTRACT

An ink set includes a non-white ink and a white ink. The non-white ink contains water, a coloring material, an organic solvent, and an acetylene glycol compound. The white ink contains water, a coloring material, an organic solvent, and a compound represented by General formula (1) below

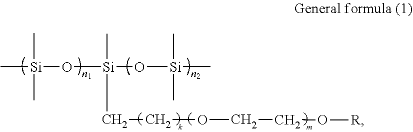

where R represents a hydrogen atom or a methyl group, n₁ and n₂ represent integers of from 1 through 7, k represents an integer of from 0 through 5, and m represents an integer of from 1 through 20.

### TECHNICAL FIELD

The present disclosure relates to a white ink, a non-white ink, an ink set, a printing set, a printing method, and a printing apparatus.

### BACKGROUND ART

In recent years, commercial printing and industrial printing fields, in which analog printing techniques such as offset printing and flexography have been the mainstream, have increasing needs for inkjet printers as a means for digital printing that can print a wide variety of designs in small lots without plates.

Print items of commercial printing are mainly, for example, pamphlets, catalogs, posters, and manuals, and print items of industrial printing are mainly, for example, labels, packages, textiles, and cardboard. Particularly, commercial printing fields prefer a wide variety of designs in small lots, for use in sales promotion of products.

Examples of such a wide-variety-in-small-lots printing include package printing for foods and daily necessities, wherein printing is applied on non-absorbable print media such as plastic films. Package printing need very high image qualities because printed matters of package printing are often seen at close range.

Hence, for example, a proposed ink set includes a first ink composition and a second ink composition each containing a silicone surfactant, wherein the total concentration of the silicone surfactant is different between the ink compositions in order to suppress mutual bleeding of the ink compositions (for example, see PTL 1).

### CITATION LIST

### Patent Literature

[PTL 1]
Japanese Unexamined Patent Application Publication No. 2016-513740

### SUMMARY OF INVENTION

### Technical Problem

The present disclosure has an object to provide an ink set that can prevent cissing and bleeding between different colors and can obtain a high image density.

### Solution to Problem

According to an aspect of the present disclosure, an ink set includes a non-white ink, which contains water, a coloring material, an organic solvent, and an acetylene glycol compound, and a white ink, which contains water, a coloring material, an organic solvent, and a compound represented by General formula (1) below.

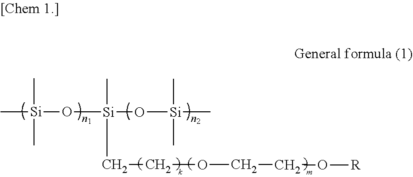

In General formula (1), R represents a hydrogen atom or a methyl group, n₁ and n₂ represent integers of from 1 through 7, k represents an integer of from 0 through 5, and m represents an integer of from 1 through 20.

### Advantageous Effects of Invention

The present disclosure can provide an ink set that can prevent cissing and bleeding between different colors and can obtain a high image density.

### BRIEF DESCRIPTION OF DRAWINGS

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

FIG. 1 is a perspective view illustrating a printing apparatus of the present disclosure.

FIG. 2 is a perspective view illustrating a main tank of the printing apparatus illustrated in FIG. 1.

FIG. 3 is a schematic view illustrating a printing apparatus of the present disclosure used in a printing method of the present disclosure.

### DESCRIPTION OF EMBODIMENTS

The terminology used herein is for the purpose of describing particular embodiments only and is not intended to be limiting of the present invention. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

(Ink Set)

An ink set of the present disclosure includes a non-white ink, which contains water, a coloring material, an organic solvent, and an acetylene glycol compound, and a white ink, which contains water, a coloring material, an organic solvent, and a compound represented by General formula (1) below.

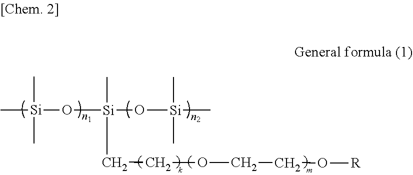

In General formula (1), R represents a hydrogen atom or a methyl group, n₁ and n₂ represent integers of from 1 through 7, k represents an integer of from 0 through 5, and m represents an integer of from 1 through 20.

Industrial printing fields such as soft packaging for foods need high productivity and machine downsizing. From these points of view, there is a need for printing a white ink onto a color ink after printing the color ink. If it is possible to omit a drying step between printing the color ink and printing the white ink, this is contributable to productivity and machine downsizing. However, existing techniques instead have had side effects of inter-color bleeding in the printing process.

The ink set of the present disclosure can obtain a high-image-quality printed matter without cis sing and bleeding of the white ink on the non-white ink. This is because the acetylene glycol compound (acetylene glycol surfactant) contained in the non-white ink and the compound (silicone surfactant) represented by General formula (1) above contained in the white ink have good wetting properties with each other.

Expression of a high wettability by the compound represented by General formula (1) above to a print medium can prevent generation of pinhole, and this enables the white ink to exhibit a high white hiding power over a solid image printed with the white ink alone. Moreover, use of the compound represented by General formula (1) above reduces the likelihood of occurrence of nozzle discharging failure even in discharging of the white ink after decapping. This is considered attributable to that the compound represented by General formula (1) above maintains the pigment of the white ink in stable dispersion even when the organic solvent vaporizes by decapping.

<White Ink>

The white ink contains water, a coloring material, an organic solvent, and a compound represented by General formula (1) below, and further contains other components as needed.

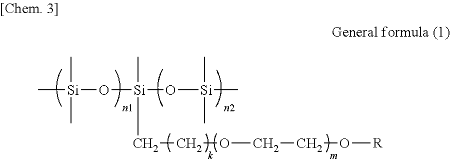

In General formula (1), R represents a hydrogen atom or a methyl group, n₁ and n₂ represent integers of from 1 through 7, k represents an integer of from 0 through 5, and m represents an integer of from 1 through 20.

The compound represented by General formula (1) above is preferably a compound represented by General formula (1-1) below.

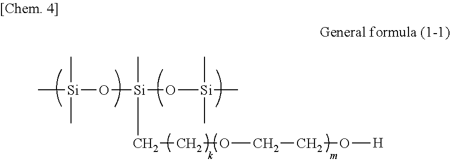

In General formula (1-1), k represents an integer of from 0 through 5 and m represents an integer of from 1 through 20.

For example, a compound represented by General formula (1a) below can be used as the compound represented by General formula (1) above. The compound represented by General formula (1) above is not limited to this compound.

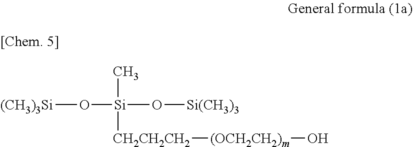

In General formula (1a), m represents an integer of from 1 through 20.

The compound represented by General formula (1) above is not particularly limited, and a commercially available product may be used. Examples of the commercially available product include, but are not limited to, BYK-3450 and BYK-348 (both available from BYK GmbH), WET-240, WET-270, and WET-280 (all available from Evonik Industries AG), and SAG503A and SAG002 (both available from Nissin Chemical Co., Ltd.).

Any other surfactant may be used in the white ink in combination with the compound represented by General formula (1) above.

Examples of the any other surfactant that can be used include, but are not limited to, silicone-based surfactants, fluorosurfactants, amphoteric surfactants, nonionic surfactants, anionic surfactants, etc. other than the compound represented by General formula (1) above. The silicone-based surfactant has no specific limit and can be suitably selected to suit to a particular application so long as the silicone-based surfactant is any other compound than the compound represented by General formula (1) above. Of these, preferred are silicone-based surfactants which are not decomposed even in a high pH environment. Specific examples thereof include, but are not limited to, side-chain-modified polydimethylsiloxane, both end-modified polydimethylsiloxane, one-end-modified polydimethylsiloxane, and side-chain-both-end-modified polydimethylsiloxane. A silicone-based surfactant having a polyoxyethylene group or a polyoxyethylene polyoxypropylene group as a modifying group is particularly preferable because such an agent demonstrates good characteristics as an aqueous surfactant. It is possible to use a polyether-modified silicone-based surfactant as the silicone-based surfactant. A specific example thereof is a compound in which a polyalkylene oxide structure is introduced into the side chain of the Si site of dimethyl siloxane.

Specific examples of the fluoro surfactants include, but are not limited to, perfluoroalkyl sulfonic acid compounds, perfluoroalkyl carboxylic acid compounds, perfluoroalkyl phosphoric acid ester compounds, adducts of perfluoroalkyl ethylene oxide, and polyoxyalkylene ether polymer compounds having a perfluoroalkyl ether group in its side chain. These are particularly preferable because they do not foam easily.

Specific examples of the perfluoroalkyl sulfonic acid compounds include, but are not limited to, perfluoroalkyl sulfonic acid and salts of perfluoroalkyl sulfonic acid.

Specific examples of the perfluoroalkyl carboxylic acid compounds include, but are not limited to, perfluoroalkyl carboxylic acid and salts of perfluoroalkyl carboxylic acid. Specific examples of the polyoxyalkylene ether polymer compounds having a perfluoroalkyl ether group in its side chain include, but are not limited to, sulfuric acid ester salts of polyoxyalkylene ether polymer having a perfluoroalkyl ether group in its side chain and salts of polyoxyalkylene ether polymers having a perfluoroalkyl ether group in its side chain. Counter ions of salts in these fluorine-based surfactants are, for example, Li, Na, K, NH₄, NH₃CH₂CH₂OH, NH₂(CH₂CH₂OH)₂, and NH(CH₂CH₂OH)₃.

Specific examples of the amphoteric surfactants include, but are not limited to, lauryl aminopropionic acid salts, lauryl dimethyl betaine, stearyl dimethyl betaine, and lauryl dihydroxy ethyl betaine.

Specific examples of the nonionic surfactants include, but are not limited to, polyoxyethylene alkyl phenyl ethers, polyoxyethylene alkyl esters, polyoxyethylene alkyl amines, polyoxyethylene alkyl amides, polyoxyethylene propylene block polymers, sorbitan aliphatic acid esters, polyoxyethylene sorbitan aliphatic acid esters, and adducts of acetylene alcohol with ethylene oxides, etc.

Specific examples of the anionic surfactants include, but are not limited to, polyoxyethylene alkyl ether acetates, dodecyl benzene sulfonates, laurates, and polyoxyethylene alkyl ether sulfates.

These surfactants can be used alone or in combination.

<<Organic Solvent>>

There is no specific limitation on the type of the organic solvent used in the present disclosure. For example, water-soluble organic solvents are suitable.

Specific examples of the water-soluble organic solvents include, but are not limited to, polyols, ethers such as polyol alkylethers and polyol arylethers, nitrogen-containing heterocyclic compounds, amides, amines, and sulfur-containing compounds.

Specific examples of the water-soluble organic solvents include, but are not limited to, polyols such as ethylene glycol, diethylene glycol, 1,2-propanediol, 1,3-propanediol, 1,2-butanediol, 1,3-butanediol, 1,4-butanediol, 2,3-butanediol, 3-methyl-1,3-butane diol, triethylene glycol, polyethylene glycol, polypropylene glycol, 1,2-pentanediol, 1,3-pentanediol, 1,4-pentanediol, 2,4-pentanediol, 1,5-pentanediol, 1,2-hexanediol, 1,6-hexanediol, 1,3-hexanediol, 2,5-hexanediol, 1,5-hexanediol, glycerin, 1,2,6-hexanetriol, 2-ethyl-1,3-hexanediol, ethyl-1,2,4-butane triol, 1,2,3-butanetriol, 2,2,4-trimethyl-1,3-pentanediol, and petriol; polyol alkylethers such as ethylene glycol monoethylether, ethylene glycol monobutylether, diethylene glycol monomethylether, diethylene glycol monoethylether, diethylene glycol monobutylether, tetraethylene glycol monomethylether, and propylene glycol monoethylether; polyol arylethers such as ethylene glycol monophenylether and ethylene glycol monobenzylether; nitrogen-containing heterocyclic compounds such as 2-pyrolidone, N-methyl-2-pyrolidone, N-hydroxyethyl-2-pyrolidone, 1,3-dimethyl-2-imidazolidinone, E-caprolactam, and γ-butyrolactone; amides such as formamide, N-methylformamide, N,N-dimethylformamide, 3-methoxy-N,N-dimethyl propionamide, and 3-butoxy-N,N-dimethyl propionamide; amines such as monoethanolamine, diethanolamine, and triethylamine; sulfur-containing compounds such as dimethyl sulfoxide, sulfolane, and thiodiethanol; propylene carbonate, and ethylene carbonate.

Since the water-soluble organic solvent serves as a humectant and also imparts a good drying property, it is preferable to use an organic solvent having a boiling point of 250 degrees C. or lower.

The proportion of the organic solvent in the white ink has no particular limit and can be suitably selected to suit a particular application.

In terms of the drying property and discharging reliability of the white ink, the proportion is preferably from 10 to 60 percent by mass and more preferably from 20 to 60 percent by mass.

<<Water>>

The water is not particularly limited and may be appropriately selected depending on the intended purpose. Examples of the water include, but are not limited to, pure water such as ion-exchanged water, ultrafiltrated water, reverse osmotic water, and distilled water, and ultrapure water.

The proportion of water in the white ink has no particular limit and can be suitably selected to suit to a particular application. In terms of the drying property and discharging reliability of the white ink, the proportion is preferably from 10 to 90 percent by mass and more preferably from 20 to 60 percent by mass.

<<Coloring Material>>

The coloring material is not particularly limited so long as the coloring material is white. Pigments and dyes can be used as the coloring material.

Examples of white pigments include, but are not limited to, titanium oxide, iron oxide, calcium carbonate, barium sulfate, and aluminum hydroxide.

Also, hollow resin particles and inorganic hollow particles can be used.

The proportion of the coloring material in the white ink is preferably from 0.1 to 15 percent by mass and more preferably from 1 to 10 percent by mass in terms of enhancement of image density, fixability, and discharging stability.

To obtain the white ink, the pigment is dispersed by, for example, preparing a self-dispersible pigment by introducing a hydrophilic functional group into the pigment, coating the surface of the pigment with resin, or using a dispersant.

To prepare a self-dispersible pigment by introducing a hydrophilic functional group into a pigment, for example, it is possible to add a functional group such as sulfone group and carboxyl group to the pigment (e.g., carbon) to disperse the pigment in water.

To coat the surface of the pigment with resin, the pigment is encapsulated by microcapsules to make the pigment dispersible in water. This can be referred to as a resin-coated pigment. In this case, the pigment to be added to ink is not necessarily wholly coated with resin.

Pigments partially or wholly uncovered with resin may be dispersed in the ink unless the pigments have an adverse impact.

To use a dispersant, for example, a known dispersant of a small molecular weight type or a high molecular weight type represented by a surfactant is used to disperse the pigments in ink. As the dispersant, it is possible to use, for example, anionic surfactants, cationic surfactants, nonionic surfactants, amphoteric surfactants, etc. depending on the pigments.

Also, a nonionic surfactant (RT-100, manufactured by TAKEMOTO OIL & FAT CO., LTD.) and a formalin condensate of naphthalene sodium sulfonate are suitable as dispersants. These dispersants can be used alone or in combination.

—Pigment dispersion—

The white ink can be obtained by mixing a pigment with materials such as water and organic solvent. It is also possible to mix a pigment with water, a dispersant, etc., first to prepare a pigment dispersion and thereafter mix the pigment dispersion with materials such as water and organic solvent to manufacture the white ink.

The pigment dispersion is obtained by mixing and dispersing water, pigment, pigment dispersant, and other optional components and adjusting the particle size. It is good to use a dispersing device for dispersion.

The particle diameter of the pigment in the pigment dispersion has no particular limit. For example, the maximum frequency in the maximum number conversion is preferably from 20 to 500 nm and more preferably from 20 to 150 nm to improve dispersion stability of the pigment and ameliorate the discharging stability and image quality such as image density. The particle diameter of the pigment can be measured using a particle size analyzer (Nanotrac Wave-UT151, manufactured by MicrotracBEL Corp).

In addition, the proportion of the pigment in the pigment dispersion is not particularly limited and can be suitably selected to suit a particular application. In terms of improving discharging stability and image density, the content is preferably from 0.1 to 50 percent by mass and more preferably from 0.1 to 30 percent by mass.

During the production, coarse particles are optionally filtered off from the pigment dispersion with a filter, a centrifuge, etc. preferably followed by degassing.

<<Resin>>

The white ink may contain a resin. Examples of the resin include, but are not limited to, urethane resins, polyester resins, acrylic-based resins, vinyl acetate-based resins, styrene-based resins, butadiene-based resins, styrene-butadiene-based resins, vinyl chloride-based resins, acrylic styrene-based resins, and acrylic silicone-based resins.

Particles of such resins may be also used. It is possible to mix a resin emulsion in which the resin particles are dispersed in water serving as a dispersion medium with materials such as a coloring agent and an organic solvent to obtain the white ink. The resin particle can be synthesized or is available on the market. It is possible to synthesize the resin particle or obtain from market. These can be used alone or in combination of the resin particles. As the resin particles, an appropriately synthesized product may be used or a commercially available product may be used. Examples of the commercially available product include, but are not limited to, MICROJEL E-1002 and E-5002 (styrene-acrylic-based resin particles, available from Nippon Paint Co., Ltd.), BONCOAT 4001 (acrylic-based resin particles, available from DIC Corporation), BONCOAT 5454 (styrene-acrylic-based resin particles, available from DIC Corporation), SAE-1014 (styrene-acrylic-based resin particles, available from Zeon Corporation), SAIVINOL SK-200 (acrylic-based resin particles, available from Saiden Chemical Industry Co., Ltd.), PRIMAL AC-22 and AC-61 (acrylic-based resin particles, available from Rohm and Haas Company), NANOCRYL SBCX-2821 and 3689 (acrylic-silicone-based resin particles, available from Toyo Ink Co., Ltd.), and #3070 (methyl methacrylate polymer resin particles, available from Mikuni Color Ltd.).

The volume average particle diameter of the resin particle is not particularly limited and can be suitably selected to suit to a particular application. The volume average particle diameter is preferably from 10 to 1,000 nm, more preferably from 10 to 200 nm, and furthermore preferably from 10 to 100 nm to obtain good fixability and image hardness. The volume average particle diameter can be measured by using a particle size analyzer (Nanotrac Wave-UT151, manufactured by MicrotracBEL Corp.).

The proportion of the resin is not particularly limited and can be suitably selected to suit to a particular application. In terms of fixability and storage stability of the white ink, it is preferably from 1 to 30 percent by mass and more preferably from 5 to 20 percent by mass to the total content of the white ink.

<<Other Components>

Examples of the other components include, but are not limited to, a defoaming agent, a preservative and fungicide, a corrosion inhibitor.

—Defoaming Agent—

The defoaming agent has no particular limit. For example, silicone-based defoaming agents, polyether-based defoaming agents, and aliphatic acid ester-based defoaming agents are suitable. These defoaming agents can be used alone or in combination. Of these defoaming agents, silicone-based defoaming agents are preferable to easily break foams.

—Preservatives and Fungicides—

The preservatives and fungicides are not particularly limited. A specific example is 1,2-benzisothiazolin-3-on.

—Corrosion Inhibitor—

The corrosion inhibitor has no particular limit. Examples thereof are acid sulfite and sodium thiosulfate.

The white ink can be produced by dispersing or dissolving the constituent components in an aqueous medium and, as needed, stirring and mixing the components. Stirring and mixing can be performed by, for example, a typical stirrer having a stirring blade, a magnetic stirrer, and a high-speed disperser.

The property of the white ink is not particularly limited and can be suitably selected to suit to a particular application. For example, viscosity, surface tension, pH, etc., are preferably in the following ranges.

The viscosity of the ink at 25 degrees C. is preferably from 5 to 30 mPa·s and more preferably from 5 to 25 mPa·s to improve print density and text quality and obtain good dischargeability. The viscosity can be measured by, for example, a rotatory viscometer (RE-80L, manufactured by TOKI SANGYO CO., LTD.). The measuring conditions are as follows:

Standard cone rotor (1° 34′×R24)

Sample liquid amount: 1.2 mL

Number of rotations: 50 rotations per minute (rpm)

−25 degrees C.

The static surface tension of the white ink is preferably 30 mN/m or lower and more preferably 26 mN/m or higher but 29 mN/m or lower at 25 degrees C.

The dynamic surface tension of the white ink measured by the maximum bubble pressure method at a surface lifetime of 15 msec is preferably 34 mN/m or lower and more preferably 32 mN/m or higher but 33.5 mN/m or lower at 25 degrees C.

It is preferable that the static surface tension and the dynamic surface tension at 15 msec of the white ink satisfy the numerical ranges described above, because the white ink can sufficiently wet a print medium or a non-white ink, prevent occurrence of pinhole, and develop a high white hiding power.

The pH of the white ink is preferably from 7 to 12 and more preferably from 8 to 11 in terms of prevention of corrosion of metal materials contacting the ink.

The white ink of the ink set of the present disclosure has an excellent discharging reliability.

<Non-White Ink>

The non-white ink contains water, a coloring material, an organic solvent, and an acetylene glycol compound, preferably contains dialkylsulfosuccinic acid or a salt thereof, and further contains other components as needed.

Because an acetylene glycol compound and dialkylsulfosuccinic acid or a salt thereof have a high wettability with the compound represented by General formula (1) above contained in the white ink, an image with little cissing and bleeding can be obtained.

<<Acetylene Glycol Compound>>

It is preferable that the acetylene glycol compound contain an acetylene glycol compound represented by General formula (2) below.

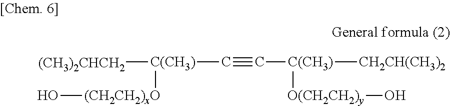

In General formula (2), x and y represent integers of 0 or greater and x+y is an integer of from 0 through 3.

A surfactant can be used as the acetylene glycol compound. Examples of the surfactant include, but are not limited to, SURFYNOL DF110D, SURFYNOL 104E, and SURFYNOL 82 (all available from Nissin Chemical Co., Ltd.).

Particularly, examples of the acetylene glycol compound represented by General formula (2) above include, but are not limited to, SURFYNOL 420, SURFYNOL 440, SURFYNOL 465, SURFYNOL 485, SURFYNOL PSA-336, E1004, and EXP4200 (all available from Nisshin Chemical Co., Ltd.).

<<Dialkylsulfosuccinic Acid or Salt Thereof>>

It is preferable that an alkyl group of dialkylsulfosuccinic acid or a salt thereof be a saturated alkyl group containing from 2 through 20 carbon atoms.

Examples of the salt of dialkylsulfosuccinic acid include, but are not limited to, sodium salt and potassium salt.

Examples of dialkylsulfosuccinic acid or a salt thereof include, but are not limited to, bis(2-ethylhexyl)sodium sulfosuccinate (available from Tokyo Chemical Industry Co., Ltd.), SANMOLINE OT (available from Sanyo Chemical Industries, Ltd.), CARABON DA-72 (available from Sanyo Chemical Industries, Ltd.), and PELEX OT-P (available from Kao Corporation).

The non-white ink may contain any other surfactant in combination with the acetylene glycol compound represented by General formula (2) above and dialkylsulfosuccinic acid or a salt thereof.

Any other surfactants same as used in the white ink described above can be used as the any other surfactant.

—Coloring Material—

The coloring material has no particular limit. For example, pigments and dyes are suitable.

The pigment includes inorganic pigments and organic pigments. These can be used alone or in combination. In addition, it is possible to use a mixed crystal.

As the pigments, for example, black pigments, yellow pigments, magenta pigments, cyan pigments, green pigments, orange pigments, gloss pigments of gold, silver, etc., and metallic pigments can be used.

As the inorganic pigments, in addition to barium yellow, cadmium red, and chrome yellow, carbon black manufactured by known methods such as contact methods, furnace methods, and thermal methods can be used.

As the organic pigments, it is possible to use azo pigments, polycyclic pigments (phthalocyanine pigments, perylene pigments, perinone pigments, anthraquinone pigments, quinacridone pigments, dioxazine pigments, indigo pigments, thioindigo pigments, isoindolinone pigments, and quinophthalone pigments, etc.), dye chelates (basic dye type chelates, acid dye type chelates, etc.), nitro pigments, nitroso pigments, and aniline black. Of these pigments, pigments having good affinity with solvents are preferable. Specific examples of the pigments for black include, but are not limited to, carbon black (C.I. Pigment Black 7) such as furnace black, lamp black, acetylene black, and channel black, metals such as copper, iron (C.I. Pigment Black 11), and titanium oxide, and organic pigments such as aniline black (C.I. Pigment Black 1).

Specific examples of the pigments for color include, but are not limited to, C.I. Pigment Yellow 1, 3, 12, 13, 14, 17, 24, 34, 35, 37, 42 (yellow iron oxide), 53, 55, 74, 81, 83, 95, 97, 98, 100, 101, 104, 108, 109, 110, 117, 120, 138, 150, 153, 155, 180, 185, and 213; C.I. Pigment Orange 5, 13, 16, 17, 36, 43, and 51; C.I. Pigment Red 1, 2, 3, 5, 17, 22, 23, 31, 38, 48:2, 48:2 (Permanent Red 2B(Ca)), 48:3, 48:4, 49:1, 52:2, 53:1, 57:1 (Brilliant Carmine 6B), 60:1, 63:1, 63:2, 64:1, 81, 83, 88, 101 (rouge), 104, 105, 106, 108 (Cadmium Red), 112, 114, 122 (Quinacridone Magenta), 123, 146, 149, 166, 168, 170, 172, 177, 178, 179, 184, 185, 190, 193, 202, 207, 208, 209, 213, 219, 224, 254, and 264; C.I. Pigment Violet 1 (Rhodamine Lake), 3, 5:1, 16, 19, 23, and 38; C.I. Pigment Blue 1, 2, 15 (Phthalocyanine Blue), 15:1, 15:2, 15:3, 15:4 (Phthalocyanine Blue), 16, 17:1, 56, 60, and 63; and C.I. Pigment Green 1, 4, 7, 8, 10, 17, 18, and 36.

The type of dye is not particularly limited and includes, for example, acidic dyes, direct dyes, reactive dyes, and basic dyes. These can be used alone or in combination.

Specific examples of the dye include, but are not limited to, C.I. Acid Yellow 17, 23, 42, 44, 79, and 142, C.I. Acid Red 52, 80, 82, 249, 254, and 289, C.I. Acid Blue 9, 45, and 249, C.I. Acid Black 1, 2, 24, and 94, C. I. Food Black 1 and 2, C.I. Direct Yellow 1, 12, 24, 33, 50, 55, 58, 86, 132, 142, 144, and 173, C.I. Direct Red 1, 4, 9, 80, 81, 225, and 227, C.I. Direct Blue 1, 2, 15, 71, 86, 87, 98, 165, 199, and 202, C.I. Direct Black 19, 38, 51, 71, 154, 168, 171, and 195, C.I. Reactive Red 14, 32, 55, 79, and 249, and C.I. Reactive Black 3, 4, and 35.

The proportion of the coloring material in the non-white ink is preferably from 0.1 to 15 percent by mass and more preferably from 1 to 10 percent by mass in terms of enhancement of image density, fixability, and discharging stability.

The same water, organic solvent, resin, and other components as used in the white ink described above can be used in the non-white ink.

The property of the non-white ink is not particularly limited and can be suitably selected to suit to a particular application. For example, viscosity, surface tension, pH, etc., are preferably in the following ranges.

The viscosity of the non-white ink at 25 degrees C. is preferably from 5 to 30 mPas and more preferably from 5 to 25 mPa s to improve print density and text quality and obtain good dischargeability. The viscosity can be measured by, for example, a rotatory viscometer (RE-80L, manufactured by TOKI SANGYO CO., LTD.). The measuring conditions are as follows:

Standard cone rotor (1° 34′ x R24)

Sample liquid amount: 1.2 mL

Number of rotations: 50 rotations per minute (rpm)

−25 degrees C.

Measuring time: three minutes

The static surface tension of the non-white ink is preferably 20 mN/m or higher but 40 mN/m or lower at 25 degrees C.

The dynamic surface tension of the non-white ink measured by the maximum bubble pressure method at a surface lifetime of 15 msec is preferably 28 mN/m or higher but 43 mN/m or lower at 25 degree C.

The pH of the non-white ink is preferably from 7 to 12 and more preferably from 8 to 11 in terms of prevention of corrosion of metal materials contacting the non-white ink.

The non-white ink of the ink set of the present disclosure has an excellent discharging reliability.

(Printing Set)

A printing set of the present disclosure includes a non-white ink, which contains water, a coloring material, an organic solvent, and an acetylene glycol compound, a white ink, which contains water, a coloring material, an organic solvent, and a compound represented by General formula (1) below, and a processing fluid, which contains water and a polyvalent metal salt.

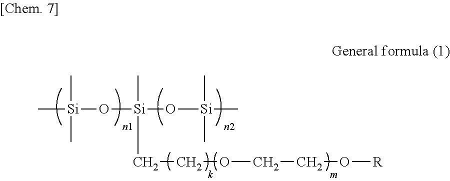

In General formula (1), R represents a hydrogen atom or a methyl group, n₁ and n₂ represent integers of from 1 through 7, k represents an integer of from 0 through 5, and m represents an integer of from 1 through 20.

The non-white ink and the white ink of the ink set of the present disclosure described above can be used as the non-white ink and the white ink.

<Processing Fluid>

The processing fluid contains water and a polyvalent metal salt, and further contains other components as needed. The processing fluid may be referred to as “pre-processing fluid”, “precoat liquid”, or “undercoat liquid”.

<<Polyvalent Metal Salt>>

The polyvalent metal salt coheres the pigments in the white ink and the non-white ink quickly after droplets of the inks land, to suppress bleeding and improve color developability. The polyvalent metal salt is not particularly limited and may be appropriately selected depending on the intended purpose. Examples of the polyvalent metal salt include, but are not limited to, salts of titanium compounds, chromium compounds, copper compounds, cobalt compounds, strontium compounds, barium compounds, iron compounds, aluminum compounds, calcium compounds, and magnesium compounds.

Among these polyvalent metal salts, salts of one or more selected from the group consisting of calcium compounds, magnesium compounds, nickel compounds, and aluminum compounds are preferable and salts of alkali earth metals such as calcium and magnesium are more preferable because these polyvalent metal salts can cohere the pigments effectively.

Specific examples of the polyvalent metal salt include, but are not limited to, calcium carbonate, calcium nitrate, calcium chloride, calcium acetate, calcium sulfate, magnesium chloride, magnesium acetate, magnesium sulfate, barium sulfate, zinc sulfide, zinc carbonate, aluminum silicate, calcium silicate, magnesium silicate, and aluminum hydroxide.

The medium of the processing fluid is an aqueous medium. However, as needed, any other medium than water may be added. Examples of any other medium include, but are not limited to, water-soluble organic solvents, surfactants, or other trace additives. The same components as used in the white ink and the non-white ink described above can be used as the water-soluble organic solvents, the surfactants, or the trace additives.

<Print Medium>

A print medium used in the present disclosure is not particularly limited and may be appropriately selected depending on the intended purpose. Examples of the print medium include, but are not limited to, plain paper, gloss paper, special paper, and cloths. Among these print media, soft packaging films are preferable.

Soft packaging films refer to polypropylene films, polyethylene terephthalate films, and nylon films.

Examples of the polypropylene films include, but are not limited to, P-2002, P-2102, P-2161, and P-4166 available from Toyobo Co., Ltd., PA-20, PA-30, and PA-20W available from SunTox Co., Ltd., and FOA, FOS, and FOR available from Futamura Chemical Co., Ltd. Examples of the polyethylene terephthalate films include, but are not limited to, E-5100 and E-5102 available from Toyobo Co., Ltd., P60 and P375 available from Toray Industries, Inc., and G2, G2P2, K, and SL available from Teijin DuPont Film Kabushiki Kaisha. Examples of the nylon films include, but are not limited to, HARDEN films N-1100, N-1102, and N-1200 available from Toyobo Co., Ltd., and ON, NX, MS, and NK available from Unitika Ltd.

(Printing Apparatus and Printing Method)

A printing method of the present disclosure includes a non-white ink applying step of applying the non-white ink of the ink set of the present disclosure to a print medium, and a white ink applying step of applying the white ink of the ink set of the present disclosure, and further includes other steps as needed.

A printing apparatus of the present disclosure includes a print medium, which is a non-absorbable soft packaging film, a non-white ink applying unit configured to apply the non-white ink of the ink set of the present disclosure, and a white ink applying unit configured to apply the white ink of the ink set of the present disclosure, and further includes other units as needed.

The method for applying an ink is not particularly limited and may be appropriately selected depending on the intended purpose. Examples of the method include, but are not limited to, inkjet methods, blade coating methods, gravure coating methods, gravure offset coating methods, bar coating methods, roll coating methods, knife coating methods, air knife coating methods, comma coating methods, U-comma coating methods, AKKU coating methods, smoothing coating methods, microgravure coating methods, reverse roll coating methods, four-roll coating methods, five-roll coating methods, dip coating methods, curtain coating methods, slide coating methods, and die coating methods. Among these methods, inkjet methods are preferable.

It is preferable that the non-white ink applying step be followed by the white ink applying step, in terms of improving image qualities on a transparent medium when seen from the non-printed surface side.

It is preferable to provide no drying step between the non-white ink applying step and the white ink applying step, in terms of reducing the machine size by omission of a drying device, and saving the power to be consumed for drying.

Examples of drying in the drying step include, but are not limited to, heating and air sending. Examples of drying do not include natural drying.

It is preferable to provide a surface reforming step of reforming a surface of a print medium.

It is preferable to perform the surface reforming step before applying the inks of the ink set to the print medium.

It is preferable to reform a surface of the print medium because the inks have a better wettability to the print medium and can form an image having no cissing. The surface reforming step is more preferably a corona treatment because the inks have an even better wettability.

<Surface Reforming Step>

In the surface reforming step, any treatment method that can eliminate application unevenness of the inks of the ink set and improve adhesiveness of the inks may be used. Examples of such a treatment method include, but are not limited to, corona treatment, atmospheric pressure plasma treatment, flame treatment, and ultraviolet irradiation treatment.

These treatment methods can be performed using known equipment.

Among the treatment methods described above, a corona treatment step of applying corona treatment to a printing surface is preferable for surface reformation of the printing surface. Corona treatment is suitable because as compared with atmospheric pressure plasma treatment, flame treatment, and ultraviolet irradiation treatment, corona treatment is excellent in output stability of corona discharge and can treat a printing surface uniformly.

It is preferable to provide a pre-processing step of applying a processing fluid, which contains water and a polyvalent metal salt, to a print medium. It is preferable to perform the processing fluid applying step before applying the inks of the ink set to a print medium.

It is more preferable to apply the processing fluid to a print medium, because when the inks land on the print medium, the inks thicken by aggregation of the coloring materials and can form an image having no bleeding.

The non-white ink of the present disclosure is used in the printing apparatus of the present disclosure. The non-white ink of the present disclosure is excellent in discharging reliability. The white ink of the present disclosure is used in the printing apparatus of the present disclosure. The white ink of the present disclosure is excellent in discharging reliability.

The ink set used in the present disclosure can be suitably applied to various printing devices employing an inkjet printing method such as printers, facsimile machines, photocopiers, multifunction peripherals (serving as a printer, a facsimile machine, and a photocopier), and 3D model manufacturing devices (3D printers, additive manufacturing device). In the present disclosure, the printing device and the printing method represent a device capable of discharging ink, various processing fluids, etc. to a print medium and a method printing an image on the print medium using the device. The print medium means an article to which the ink or the various processing fluids can be attached at least temporarily. The printing device may further optionally include a device relating to feeding, conveying, and ejecting the print medium and other devices referred to as a pre-processing device, a post-processing device, etc. in addition to the head portion to discharge the ink. The printing device and the printing method may further optionally include a heater for use in the heating process and a drier for use in the drying process. For example, the heating device and the drying device heat and dry the top surface and the bottom surface of a print medium having an image. The heating device and the drying device are not particularly limited. For example, a fan heater and an infra-red heater can be used. The print medium can be heated and dried before, during, and after printing.

An apparatus may be free of a heater for use in the heating process and a drier for use in the drying process between the non-white ink applying step and the white ink applying step. An apparatus free of a heater and a drier can be reduced in size.

In addition, the printing device and the printing method are not limited to those producing merely meaningful visible images such as texts and figures with the ink. For example, the printing device and the printing method can produce patterns like geometric design and 3D images.

In addition, the printing device includes both a serial type device in which the liquid discharging head is caused to move and a line type device in which the liquid discharging head is not moved, unless otherwise specified.

Furthermore, in addition to the desktop type, this printing device includes a wide type capable of printing images on a large print medium such as AO, a continuous printer capable of using continuous paper wound up in a roll form as print media.

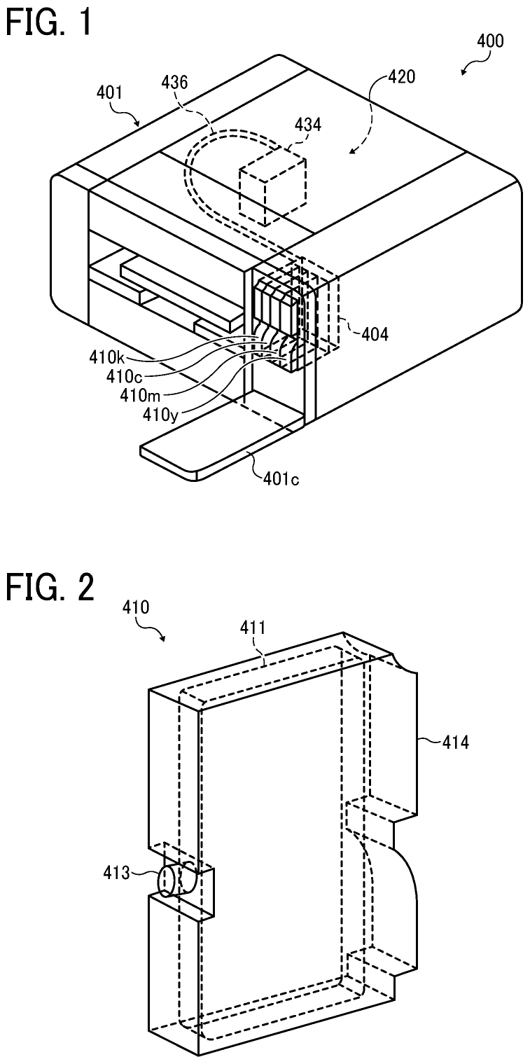

The printing device of the present disclosure is described using an example with reference to FIG. 1 and FIG. 2. FIG. 1 is a perspective view illustrating the image printing device. FIG. 2 is a perspective view illustrating the main tank. An image forming apparatus 400 as an example of the printing device is a serial type image forming apparatus. A mechanical unit 420 is disposed in an exterior 401 of the image forming apparatus 400. Each ink accommodating unit (ink container) 411 of each main tank 410 (410k, 410c, 410m, and 410y) for each color of black (K), cyan (C), magenta (M), and yellow (Y) is made of a packing member such as aluminum laminate film. The ink container 411 is accommodated in a plastic housing unit 414. As a result, the main tank 410 is used as an ink cartridge of each color. A cartridge holder 404 is disposed on the rear side of the opening when a cover 401c of the main body is opened. The cartridge holder 404 is detachably attached to the main tank 410. As a result, each ink discharging outlet 413 of the main tank 410 is communicated with a discharging head 434 for each color via a supplying tube 436 for each color so that the ink can be discharged from the discharging head 434 to a print medium.

This printing device may include not only a portion discharging ink but also a device referred to as a pre-processing device, a post-processing device, etc.

As an example of the pre-processing device and the post-processing device, as in the case of the ink such as black (K), cyan (C), magenta (M), and yellow (Y), a liquid container containing a pre-processing fluid or a post-processing fluid and a liquid discharging head are added to discharge the pre-processing fluid or the post-processing fluid in an inkjet printing method.

As another example of the pre-processing device and the post-processing device, it is suitable to dispose a pre-processing device and a post-processing device employing a blade coating method, a roll coating method, or a spray coating method other than the inkjet printing method.

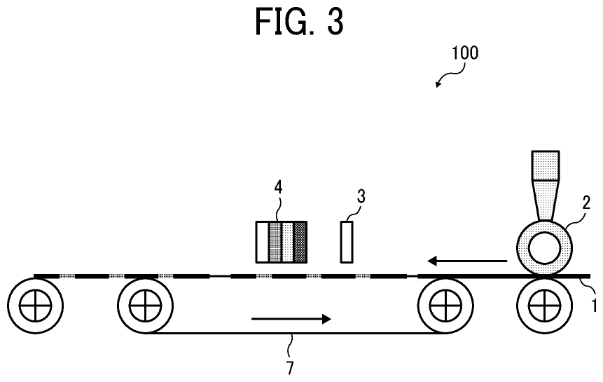

FIG. 3 is a schematic view illustrating an example of a printing apparatus used in the printing method of the present disclosure. The printing apparatus 100 of FIG. 3 includes a processing fluid applying device 2 configured to apply a processing fluid, a white ink discharging head 3 configured to discharge a white ink (W), a non-white ink (color ink) discharging head 4 configured to discharge a black ink (K), a cyan ink (C), a magenta ink (M), and a yellow ink (Y), which are non-white inks, and a conveyor belt 7 configured to convey a print medium 1.

How to use the ink is not limited to the inkjet printing method. Specific examples of such methods other than the inkjet printing method include, but are not limited to, blade coating methods, gravure coating methods, bar coating methods, roll coating methods, dip coating methods, curtain coating methods, slide coating methods, die coating methods, and spray coating methods.

Moreover, image forming, recording, printing, etc. in the present disclosure represent the same meaning.

Recording media, media, and print media represent the same meaning.

### EXAMPLES

The present disclosure will be described below by way of Examples. The present disclosure should not be construed as being limited to these Examples. Unless otherwise particularly specified, preparation and evaluation of Examples and Comparative Examples were performed at 25 degrees C. at a relative humidity of 60%. Examples described below are examples in which a pre-processing fluid to be applied before printing was used as a processing fluid.

(Pigment Dispersion Preparation Example 1)

<Preparation of Black Pigment Dispersion>

The following formula ingredients were pre-mixed, and subsequently subjected to circulation dispersion treatment for 7 hours using a disk-type bead mill (obtained from Shinmaru Enterprises Corporation, KDL TYPE, using zirconia balls having a diameter of 0.3 mm as media), to obtain a black pigment dispersion (with a pigment concentration of 15% by mass).

[Formulation for black pigment dispersion]

Carbon black (product name: MONARCH 800, obtained from Cabot Corporation): 15 parts by mass

Acrylic-based polymeric dispersant (product name: DISPERBYK-2010, obtained from BYK Japan K.K.): 5 parts by mass

Ion-exchanged water: 80 parts by mass

(Pigment Dispersion Preparation Example 2)

<Preparation of Cyan Pigment Dispersion>

A cyan pigment dispersion (with a pigment solid concentration of 15% by mass) was obtained in the same manner as in Pigment dispersion preparation example 1, except that unlike in Pigment dispersion preparation example 1, carbon black was changed to pigment blue 15:3.

(Pigment dispersion preparation example 3)

<Preparation of Magenta Pigment Dispersion>

A magenta pigment dispersion (with a pigment solid concentration of 15% by mass) was obtained in the same manner as in Pigment dispersion preparation example 1, except that unlike in Pigment dispersion preparation example 1, carbon black was changed to pigment red 269.

(Pigment Dispersion Preparation Example 4)

<Preparation of Yellow Pigment Dispersion>

A yellow pigment dispersion (with a pigment solid concentration of 15% by mass) was obtained in the same manner as in Pigment dispersion preparation example 1, except that unlike in Pigment dispersion preparation example 1, carbon black was changed to pigment yellow 74.

(Pigment Dispersion Preparation Example 5)

<Preparation of White Pigment Dispersion>

Titanium oxide (product name: STR-100W, obtained from Sakai Chemical Industry Co., Ltd.) (25 parts by mass), a pigment dispersant (product name: TEGO DISPERS 651, obtained from Evonik Industries AG) (5 parts by mass), and water (70 parts by mass) were mixed, and subjected to dispersion treatment for 5 minutes using a bead mill (product name: RESEARCH LABO, obtained from Shinmaru Enterprises Corporation) at 8 m/s at a 60% packing ratio of zirconia beads having a diameter of 0.3 mm, to obtain a white pigment dispersion (with a pigment solid concentration of 25% by mass).

(Resin Particle Dispersion Liquid Production Example 1)

<Production of Acrylic Resin Particle Dispersion Liquid 1>

A mixture formed of methyl methacrylate (65 parts by mass), 2-ethylhexyl acrylate (31 parts by mass), methacrylic acid (2 parts by amass), AQUALON HS-10 (obtained from Dai-Ichi Kogyo Seiyaku Co., Ltd.) (2 parts by mass), and ion-exchanged water (52 parts by mass) was emulsified using a homomixer, to obtain a uniform, milky-white emulsified liquid.

A 250 mL flask equipped with a stirrer, a thermometer, a nitrogen gas introducing pipe, and a reflux condenser was charged with ion-exchanged water (89 parts by mass) and raised to a temperature of 70 degrees C. while nitrogen was introduced into the flask. Next, a 10% by mass aqueous solution (0.8% part by mass) of AQUALON HS-10 (obtained from Dai-ichi Kogyo Seiyaku Co., Ltd.) and a 5% by mass ammonium persulfate aqueous solution (2.6 parts by mass) were fed into the flask, and subsequently the emulsified liquid prepared previously was dropped into the flask continuously for 2.5 hours Until before three hours passed from when dropping was started, a 5% by mass ammonium persulfate aqueous solution (0.6% by mass) was fed into the flask once every hour. After dropping was completed, the resultant was aged at 70 degrees C. for 2 hours, then cooled, and adjusted to pH of from 7 through 8 with 28% by mass ammonia water, to obtain an acrylic resin particle dispersion liquid 1.

The glass transition temperature Tg of the obtained acrylic resin particles was 53 degrees C. The Tg was measured by DSC (obtained from Rigaku Corporation, THERMO PLUS EVO2/DSC).

(Resin Particle Dispersion Liquid Production Example 2)

<Production of Acrylic Resin Particle Dispersion Liquid 2>

An acrylic resin particle dispersion liquid 2 was obtained in the same manner as in Resin particle dispersion liquid production example 1, except that unlike in Resin particle dispersion liquid production example 1, methyl methacrylate was changed to 69 parts by mass and 2-ethylhexyl acrylate was changed to 27 parts by mass.

The glass transition temperature Tg of the obtained acrylic resin particles was 62 degrees C.

(Resin Particle Dispersion Liquid Production Example 3)

<Production of Acrylic Resin Particle Dispersion Liquid 3>

An acrylic resin particle dispersion liquid 3 was obtained in the same manner as in Resin particle dispersion liquid production example 1, except that unlike in Resin particle dispersion liquid production example 1, methyl methacrylate was changed to 77 parts by mass and 2-ethylhexyl acrylate was changed to 19 parts by mass.

The glass transition temperature Tg of the obtained acrylic resin particles was 85 degrees C.

(Resin Particle Dispersion Liquid Production Example 4)

<Preparation of Urethane Resin Emulsion A>

A diisocyanate compound (0.1 moles) obtained by allowing dicyclohexylmethane diisocyanate (1.4 moles) to react with 1,6-hexanediol (1 mole) and allowing polyethylene glycol monomethyl ether having a molecular weight of 1,000 (1/3 moles) to react with isocyanurate trimer (1 mole) of 1,6-hexamethylene diisocyanate, and N-methyl-2-pyrrolidone in an amount of 15% by mass of the total mass were fed into a reaction flask and allowed to react at 90 degrees C. for 2 hours under a nitrogen gas stream, to obtain a prepolymer.

Next, the obtained prepolymer composition (450 g) having a solid concentration of 85% by mass was dropped for 15 minutes into water (600 g) in which a silicone-based defoaming agent (SE-21, obtained from Wacker Silicone Co., Ltd.) (0.2 g) was dissolved, and stirred at 25 degrees C. for 10 minutes. Subsequently, a compound represented by Structural formula (2) below, ethylenediamine, and adipic acid hydrazide were dropped into the resultant, to obtain a urethane resin emulsion A.

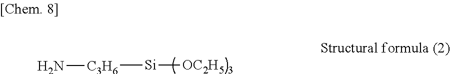

(Non-White Ink Production Example 1)

<Preparation of Non-White Ink 1>

The following formula ingredients for a non-white ink 1 were mixed and stirred, and filtrated through a polypropylene filter having an average pore diameter of 0.8 micrometers, to produce a non-white ink 1.

[Formulation for Non-White Ink 1]

Black pigment dispersion: 20 parts by mass

SURFYNOL 420 (obtained from Nissin Chemical Industry Co., Ltd.): 0.25 parts by mass

Bis(2-ethylhexyl)sodium sulfosuccinate (obtained from Tokyo Chemical Industry Co., Ltd.): 0.25 parts by mass

PROXEL LV (obtained from Avecia Inc., a preservative): 0.1 parts by mass

1,2-Propanediol: 19 parts by mass

Ethylene glycol monobutyl ether: 10 parts by mass

Ion-exchanged water: 50.4 parts by mass

(Non-White Ink Production Examples 2 to 11)

<Preparation of Non-White Inks 2 to 11>

Non-white inks 2 to 11 were produced in the same manner as in Non-white ink production example 1, except that unlike in Non-white ink production example 1, the ink formulation was changed to as described in Table 1-1 and Table 1-2.

TABLE 1-1

| | | Non-white ink No. | | | | | |
|---|---|---|---|---|---|---|---|
| | | 1 | 2 | 3 | 4 | 5 | 6 |
| Coloring | Black pigment dispersion | 20 | | | | 20 | |
| material | Cyan pigment dispersion | | 20 | | | | 20 |
| | Magenta pigment dispersion | | | 20 | | | |
| | Yellow pigment dispersion | | | | 20 | | |
| Surfactant | SURFYNOL 420 | 0.25 | | | | | |
| | SURFYNOL PSA-33 | | | | 0.25 | | 1 |
| | SURFYNOL 440 | | | | | 0.5 | |
| | SURFYNOL 465 | | | | | | |
| | SURFYNOL 485 | | | | | | |
| | SURFYNOL DF110D | | | 0.5 | | | |
| | SURFYNOL 104E | | 0.25 | | | | |
| | SURFYNOL 82 | | | | | | |
| | Bis(2-ethylhexyl)sodium sulfosuccinate | 0.25 | | | | | |
| | SANMOLINE OT | | 0.25 | | | 0.2 | |
| | PELEX OT-P | | | | 0.25 | | |
| | Fluorine-based surfactant FS-300 | | | | | | |
| Resin | Acrylic resin dispersion liquid 1 | | | | 10 | | |
| | Acrylic resin dispersion liquid 2 | | | | | | 10 |
| | Acrylic resin dispersion liquid 3 | | | | | | |
| | Urethane resin emulsion A | | | | | 5 | |
| Organic | 1,2-Propanediol | 15 | | | | | 20 |
| solvent | 1,3-Butanediol | | | | 15 | | |
| | 1,3-Propanediol | | 15 | | | 15 | |
| | Glycerin | | | 15 | 10 | | |
| | Ethylene glycol monobutyl ether | 10 | | | | | |
| | 3-Methoxy-3-methyl-1-butanol | | 10 | | | 10 | 5 |
| | Dipropylene glycol monomethyl ether | | | 10 | | | |
| Antibacterial | PROXEL LV | 0.1 | 0.1 | 0.1 | 0.1 | 0.1 | 0.1 |
| agent | | | | | | | |
| Water | Ion-exchanged water | Balance | Balance | Balance | Balance | Balance | Balance |

| | | | | | | |
|---|---|---|---|---|---|---|
| Total (% by mass) | 100 | 100 | 100 | 100 | 100 | 100 |

TABLE 1-2

| | | Non-white ink No. | | | | |
|---|---|---|---|---|---|---|
| | | 7 | 8 | 9 | 10 | 11 |
| Coloring | Black pigment dispersion | | | 20 | 20 | 20 |
| material | Cyan pigment dispersion | | | | | |
| | Magenta pigment dispersion | 20 | | | | |
| | Yellow pigment dispersion | | 20 | | | |
| Surfactant | SURFYNOL 420 | | | 0.3 | | |
| | SURFYNOL PSA-33 | | | | | |
| | SURFYNOL 440 | | | | | |
| | SURFYNOL 465 | 0.5 | | | | |
| | SURFYNOL 485 | | 0.5 | | | |
| | SURFYNOL DF110D | | | | | |
| | SURFYNOL 104E | | | | 0.5 | |
| | SURFYNOL 82 | | | | | |
| | Bis(2-ethylhexyl)sodium sulfosuccinate | 0.2 | | | | |
| | SANMOLINE OT | | | 0.5 | | |
| | PELEX OT-P | | 0.5 | | | |
| | Fluorine-based surfactant FS-300 | | | | | 0.5 |
| Resin | Acrylic resin dispersion liquid 1 | | 10 | | | |
| | Acrylic resin dispersion liquid 2 | | | | | |
| | Acrylic resin dispersion liquid 3 | | | | | 10 |
| | Urethane resin emulsion A | | | | | |
| Organic solvent | 1,2-Propanediol | | | | 20 | 20 |
| | 1,3-Butanediol | 13 | | 20 | | |
| | 1,3-Propanediol | | 12 | | | 15 |
| | Glycerin | | 14 | | | |
| | Ethylene glycol monobutyl ether | 13 | | | 7 | |
| | 3-Methoxy-3-methyl-1-butanol | | | | | 10 |
| | Dipropylene glycol monomethyl ether | | | 7 | | |
| Antibacterial | PROXEL LV | 0.1 | 0.1 | 0.1 | 0.1 | 0.1 |
| agent | | | | | | |
| Water | Ion-exchanged water | Balance | Balance | Balance | Balance | Balance |

| | | | | | |
|---|---|---|---|---|---|
| Total (% by mass) | 100 | 100 | 100 | 100 | 100 |

The details of the components in Table 1-1 and Table 1-2 are as follows.

<Surfactant>

—Acetylene Glycol Compound Represented by General Formula (2) Above—

SURFYNOL 420 (obtained from Nissin Chemical Co., Ltd.)

SURFYNOL PSA-33 (obtained from Nissin Chemical Co., Ltd.)

SURFYNOL 440 (obtained from Nissin Chemical Co., Ltd.)

SURFYNOL 465 (obtained from Nissin Chemical Co., Ltd.)

SURFYNOL 485 (obtained from Nissin Chemical Co., Ltd.)

—Acetylene Glycol Compound Other than General Formula (2) Above—

SURFYNOL DF110D (obtained from Nissin Chemical Co., Ltd.)

SURFYNOL 104E (obtained from Nissin Chemical Co., Ltd.)

SURFYNOL 82 (obtained from Nissin Chemical Co., Ltd.)

—Dialkylsulfosuccinic Acid or Salt Thereof—

Bis(2-ethylhexyl)sodium sulfosuccinate (obtained from Tokyo Chemical Industry Co., Ltd.)

SANMOLINE OT (obtained from Sanyo Chemical Industries, Ltd.)

PELEX OT-P (obtained from Kao Corporation)

—Fluorine-Based Surfactant—

FS-300 (obtained from DuPont Kabushiki Kaisha)

(White Ink Production Example 1)

<Preparation of White Ink 1>

The following formula ingredients for a white ink 1 were mixed and stirred, and filtrated through a polypropylene filter having an average pore diameter of 0.8 micrometers, to produce a white ink 1.

[Formulation for White Ink 1]

White pigment dispersion: 48 parts by mass

BYK-3450 (obtained from BYK GmbH): 0.5 parts by mass

PROXEL LV (obtained from Avecia Inc., a preservative): 0.1 parts by mass

1,2-Propanediol: 15 parts by mass

Ethylene glycol monobutyl ether: 10 parts by mass

Ion-exchanged water: 26.4 parts by mass

(White Ink Production Examples 2 to 13)

<Preparation of White Inks 2 to 13>

White inks 2 to 13 were produced in the same manner as in White ink production example 1, except that unlike in White ink production example 1, the ink formulation was changed to as described in Table 2-1 and Table 2-2.

Next, the static surface tension and the dynamic surface tension at 15 msec of the obtained white inks were measured in the manners described below. The results are presented in Table 2-1 and Table 2-2.

<Measurement of Static Surface Tension>

The static surface tension of the white ink was measured using an automatic surface tensiometer (DY-300, obtained from Kyowa Interface Science Co., Ltd.) at 25 degrees C. More specifically, the white ink was poured into a petri dish having a diameter of 30 mm and left to stand still for 5 minutes, and the static surface tension of the white ink was measured with the automatic surface tensiometer DY-300 according to Wilhelmy method using a platinum plate.

<Measurement of Dynamic Surface Tension at 15 Msec>

The dynamic surface tension of the white ink at a surface lifetime of 15 msec by the maximum bubble pressure method was measured using SITA DYNO TESTER (obtained from SITA) at 25 degrees C. More specifically, the white ink (30 ml) was poured into a 30 ml beaker and then left to stand still for 10 minutes in a water bath adjusted to 25 degrees C. to adjust the temperature of the white ink to 25 degrees C., and the dynamic surface tension of the white ink at 15 msec was measured with SITA DYNO TESTER.

TABLE 2-1

| | | White ink | | | | | | |
|---|---|---|---|---|---|---|---|---|
| | | 1 | 2 | 3 | 4 | 5 | 6 | 7 |
| Coloring | White pigment dispersion | 48 | 48 | 48 | 48 | 48 | 48 | 48 |
| material | | | | | | | | |
| Surfactant | BYK-3450 | 0.5 | | | 0.3 | | | 0.5 |
| | BYK 348 | | 0.5 | | | | | |
| | WET-270 | | | 1 | 0.3 | | | |
| | WET-280 | | | | | 0.5 | | |
| | SAG 503A | | | | | | 0.3 | |
| | WET-240 | | | | | | | |
| | SAG 002 | | | | | | | |
| | FS-300 | | | | | | | |
| Resin | Resin dispersion liquid 1 | | 10 | | | | 5 | |
| dispersion | Resin dispersion liquid 2 | | | 5 | | | | |
| liquid | Resin dispersion liquid 3 | | | | 10 | | | |
| | Urethane resin emulsion A | | | | | | | |
| Organic solvent | 1,2-Proanediol | 15 | | 15 | | | | 15 |
| | 1,3-Butanediol | | 12 | | | 15 | | |
| | 1,3-Propanediol | | | | 10 | | 15 | |
| | Ethylene glycol monobutyl ether | 10 | | | | 12 | | |
| | 3-Methoxy-3-methyl-1-butanol | | 10 | 10 | | | 10 | |
| | Dipropylene glycol monomethyl ether | | | | 10 | | | 10 |
| Antibacterial | PROXEL LV | 0.1 | 0.1 | 0.1 | 0.1 | 0.1 | 0.1 | 0.1 |
| agent | | | | | | | | |
| Water | Ion-exchanged water | Balance | Balance | Balance | Balance | Balance | Balance | Balance |
| Total (% by mass) | | 100 | 100 | 100 | 100 | 100 | 100 | 100 |
| Surface tension | Static surface tension [mN/m] | 28.8 | 29.3 | 28 | 28.4 | 29 | 29.5 | 28.6 |
| | Dynamic surface tension at 15 msec [mN/m] | 33.0 | 32.8 | 32 | 32.1 | 32.7 | 33.8 | 32.7 |

TABLE 2-2

| | | White ink | | | | | |
|---|---|---|---|---|---|---|---|
| | | 8 | 9 | 10 | 11 | 12 | 13 |
| Coloring | White pigment dispersion | 48 | 48 | 48 | 48 | 48 | 48 |
| material | | | | | | | |
| Surfactant | BYK-3450 | | | 0.1 | | | |
| | BYK 348 | | | | | | |
| | WET-270 | 0.1 | | | | | |
| | WET-280 | | | | | 0.5 | |
| | SAG 503A | | | | | | |
| | WET-240 | | 0.5 | | | | |
| | SAG 002 | | | | | | 0.5 |
| | FS-300 | | | | 0.5 | | |
| Resin | Resin dispersion liquid 1 | | | | | | 10 |
| dispersion | Resin dispersion liquid 2 | | | | | | |
| liquid | Resin dispersion liquid 3 | | | | | | |
| | Urethane resin emulsion A | | 5 | | | | |
| Organic solvent | 1,2-Proanediol | 15 | | | 15 | 15 | |
| | 1,3-Butanediol | | 15 | | | | 12 |
| | 1,3-Propanediol | | | 15 | 10 | | |
| | Ethylene glycol monobutyl ether | | 10 | | | 10 | |
| | 3-Methoxy-3-methyl-1-butanol | | | 10 | | | 10 |
| | Dipropylene glycol monomethy l ether | 10 | | | | | |
| Antibacterial | PROXEL LV | 0.1 | 0.1 | 0.1 | 0.1 | 0.1 | 0.1 |
| agent | | | | | | | |
| Water | Ion-exchanged water | Balance | Balance | Balance | Balance | Balance | Balance |
| Total (% by mass) | | 100 | 100 | 100 | 100 | 100 | 100 |
| Surface tension | Static surface tension [mN/m] | 31.5 | 29.3 | 32.2 | 27.8 | 28.7 | 29.5 |
| | Dynamic surface tension at 15 msec [mN/m] | 34.9 | 33.4 | 35.4 | 31.9 | 32.9 | 33.7 |

TABLE 2-3

| | | R, K, n₁, n₂, and m in General formula (1) | | | | |
|---|---|---|---|---|---|---|
| | | R | k | n₁ | n₂ | m |
| Surfactant | BYK-3450 | H | 2 | 1 | 1 | 2 to 13 |
| | BYK 348 | H | 2 | 1 to 6 | 1 to 6 | 2 to 20 |
| | WET-270 | CH₃ | 2 | 1 to 7 | 1 to 7 | 2 to 17 |
| | WET-280 | CH₃ | 2 | 1 to 6 | 1 to 6 | 2 to 17 |
| | SAG 503A | H | 2 | 1 to 5 | 1 to 5 | 3 to 19 |
| | WET-240 | H | 2 | 1 | 1 | 2 to 16 |
| | SAG 002 | CH₃ | 2 | 1 | 1 | 2 to 20 |
| | FS-300 | — | — | — | — | — |

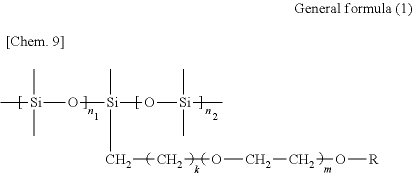

The details of the components in Table 2-1 to Table 2-3 are as follows.

<Surfactant>

—Compound Represented by General Formula (1) Above—

BYK-348 (a silicone surfactant, obtained from BYK GmbH)

BYK-3450 (a silicone surfactant, obtained from BYK GmbH)

WET-240 (a silicone surfactant, obtained from Evonik Industries AG)

WET-270 a (silicone surfactant, obtained from Evonik Industries AG)

WET-280 (a silicone surfactant, obtained from Evonik Industries AG)

SAG503A (a silicone surfactant, obtained from Nissin Chemical Co., Ltd.)

SAG002 (a silicone surfactant, obtained from Nissin Chemical Co., Ltd.)

—Fluorine-Based Surfactant—

FS-300 (obtained from DuPont Kabushiki Kaisha)

(Pre-Processing Fluid Production Example 1)

<Preparation of Pre-Processing Fluid 1>

The following formula ingredients for a pre-processing fluid 1 were weighed out, then mixed and stirred, and filtrated through a filter having an average pore diameter of 5 micrometers

(Obtained from Sartorius AG, MINISART).

[Formulation for Pre-Processing Fluid 1]

1,2-Propanediol: 15 parts by mass

Ethylene glycol monobutyl ether: 13 parts by mass

EMULGEN LS-106 (obtained from Kao Corporation, a surfactant): 0.5 parts by mass

Magnesium sulfate: 3.0 parts by mass

PROXEL LV (obtained from Avecia Inc., a preservative): 0.1 parts by mass

Ion-exchanged water: 68.4 parts by mass

(Pre-processing fluid production examples 2 to 9)

<Preparation of pre-processing fluids 2 to 9>

Pre-processing fluids 2 to 9 were produced in the same manner as in Pre-processing fluid production example 1, except that unlike in Pre-processing fluid production example 1, the formulation for the pre-processing fluid was changed to as described in Table 3-1 and Table 3-2.

TABLE 3-1

| | | Pre-processing fluid No. | | | | |
|---|---|---|---|---|---|---|
| | | 1 | 2 | 3 | 4 | 5 |
| Polyvalent | Magnesium sulfate | 3 | | | | |
| metal salt | Magnesium acetate | | 3 | | | |
| | Calcium carbonate | | | 2 | | |
| | Calcium nitrate | | | | 4 | |
| | Calcium acetate | | | | | 3 |
| | Aluminum silicate | | | | | |
| | Aluminum hydroxide | | | | | |
| Surfactant | EMULGEN LS-106 | 0.5 | | | | |
| | BYK-333 | | 0.5 | | | |
| | BYK-3450 | | | 0.5 | | |
| | WET-270 | | | | 0.5 | |
| | WET-280 | | | | | 0.5 |
| | SAG503A | | | | | |
| | SAG016 | | | | | |
| Organic | 1,2-Propanediol | 15 | | 20 | 7 | 10 |
| solvent | 1,3-Butanediol | | 15 | | | |
| | Ethylene glycol monobutyl ether | 13 | | | | 17 |
| | 3-Methoxy-3-methyl-1-butanol | | 10 | 5 | 20 | |
| Antibacterial | PROXEL LV | 0.1 | 0.1 | 0.1 | 0.1 | 0.1 |
| agent | | | | | | |
| Water | Ion-exchanged water | Balance | Balance | Balance | Balance | Balance |

| | | | | | |
|---|---|---|---|---|---|
| Total (% by mass) | 100 | 100 | 100 | 100 | 100 |

TABLE 3-2

| | | Pre-processing fluid No. | | | |
|---|---|---|---|---|---|
| | | 6 | 7 | 8 | 9 |
| Polyvalent | Magnesium sulfate | | | 4 | |
| metal salt | Magnesium acetate | | | | |
| | Calcium carbonate | | | | |
| | Calcium nitrate | | | | |
| | Calcium acetate | | | | |
| | Aluminum silicate | 3 | | | |
| | Aluminum hydroxide | | 3 | | |
| Surfactant | EMULGEN LS-106 | | | 0.5 | |
| | BYK-333 | | | | 0.5 |
| | BYK-3450 | | | | |
| | WET-270 | | | | |
| | WET-280 | | | | |
| | SAG503A | 0.5 | | | |
| | SAG016 | | 0.5 | | |
| Organic | 1,2-Propanediol | | | 15 | 15 |
| solvent | 1,3-Butanediol | | 10 | 13 | |
| | Ethylene glycol | 8 | | | |
| | monobutyl ether | | | | |
| | 3-Methoxy-3- | 17 | 18 | | 13 |
| | methyl-1-butanol | | | | |
| Antibac- | PROXEL LV | 0.1 | 0.1 | 0.1 | 0.1 |
| terial | | | | | |
| agent | | | | | |
| Water | Ion-exchanged water | Balance | Balance | Balance | Balance |

| | | | | |
|---|---|---|---|---|
| Total (% by mass) | 100 | 100 | 100 | 100 |

The details of the components in Table 3-1 and Table 3-2 are as follows.

—Surfactant—

EMULGEN LS-106 (a polyoxyalkyl ether surfactant, obtained from Kao Corporation)

BYK-333 (a silicone surfactant, obtained from BYK GmbH)

BYK-3450 (a silicone surfactant, obtained from BYK GmbH)

WET-270 (a silicone surfactant, obtained from Evonik Industries AG)

WET-280 (a silicone surfactant, obtained from Evonik Industries AG)

SAG503A (a silicone surfactant, obtained from Nissin Chemical Co., Ltd.)

SAG016 (a silicone surfactant, obtained from Nissin Chemical Co., Ltd.)

(Examples 1 to 13 and Comparative Examples 1 and 2)

<Image Formation>

In an environment adjusted to 23 degrees C.±0.5 degrees C. and 50% RH±5% RH, for each combination of the white ink, the non-white ink, and the pre-processing fluid presented in Table 4-1 to Table 4-3, an image forming apparatus (IPSIO GXE-5500, obtained from Ricoh Company, Ltd.) was set by variation of a piezo element driving voltage in a manner that the amounts of the white ink and the non-white ink to be discharged would be the same, and used under the setting that the white ink and the non-white ink would be attached in the same amount (5 g/m²) to a biaxially stretched polypropylene (OPP) soft packaging film (obtained from Toyobo Co., Ltd., PYLENE P2102) to which the pre-processing fluid was previously applied in an amount of 3 g/m² with a bar coater No. 1 and then dried at 80 degrees C. for 2 minutes, to form solid (uniform) images. The white ink and the non-white ink were discharged in a manner that after the non-white ink was discharged, the white ink was discharged.

Various properties were evaluated in the manners described below. The results are presented in Table 4-1 to Table 4-3.

<Evaluation of Cis Sing>

A solid image of the white ink was formed on the non-white ink in the manner described above. The solid image of the non-white ink coated with the white ink was observed to evaluate cissing according to the criteria described below. The ratings B and A are practically usable levels.

<Evaluation Criteria>

A: The solid image of the non-white ink was not exposed to the outside and the solid image of the white ink was uniform.

B: The solid image of the non-white ink was not exposed to the outside, but the solid image of the white ink was slightly non-uniform.

C: The solid image of the non-white ink was not exposed to the outside, but the solid image of the white ink was significantly non-uniform.

D: The solid image of the non-white ink was exposed to the outside.

<White Hiding Power>

In an environment adjusted to 23 degrees C.±0.5 degrees C. and 50% RH±5% RH, an image forming apparatus (IPSIO GXE-5500, obtained from Ricoh Company, Ltd.) was set by variation of a piezo element driving voltage in a manner that the amount of the white ink to be attached would be 5 g/m², to form a solid image of the white ink on OPP (obtained from Toyobo Co., Ltd., PYLENE P2102) to which the pre-processing fluid was previously applied in an amount of 3 g/m² with a bar coater No. 1 and then dried at 80 degrees C. for 2 minutes. The formed image was put on paper for measuring the hiding ratio (obtained from TP Giken, Co., Ltd.) to measure the black (Bk) density with X-RITE EXACT (obtained from X-Rite Inc.) and evaluate the white hiding power according to the criteria described below. The ratings B and A are practically usable levels.

<Evaluation Criteria>

A: The image density was lower than 0.30.

B: The image density was 0.30 or higher but lower than 0.40.

C: The image density was 0.40 or higher but lower than 0.50.

D: The image density was 0.50 or higher.

<Evaluation of Dischargeability>

An inkjet printer (apparatus name: IPSIO GXE5500 remodeled apparatus, obtained from Ricoh Company, Ltd.) was filled with the inks to evaluate dischargeability of the inks after decapping.

First, in an environment at 25 degrees C. at 20% RH, the head of the inkjet printer was cleaned based on a maintenance command of the inkjet printer, and a test chart was printed to confirm that all nozzle channels were dischargeable.

Next, the inkjet printer was left to stand for 10 minutes with the cap of the head removed, and a test chart was printed again. Based on the test charts before and after leaving to stand, the number of non-dischargeable channels was counted and evaluated according to the criteria described below. For the inks to be practically usable, the number of non-dischargeable channels should be less than ten.

<Evaluation Criteria>

A: The number of non-dischargeable channels was one or less.

B: The number of non-dischargeable channels was two or greater but less than ten.

C: The number of non-dischargeable channels was ten or greater.

<Evaluation of Bleeding>

In an environment adjusted to 23 degrees C.±0.5 degrees C. and 50% RH±5% RH, for the white ink, the non-white ink, and the pre-processing fluid, an image forming apparatus (IPSIO GXE-5500, obtained from Ricoh Company, Ltd.) was set by variation of a piezo element driving voltage in a manner that the amounts of the white ink and the non-white ink to be discharged would be the same, and used under the setting that the white ink and the non-white ink would be attached in the same amount (5 g/m²) to a biaxially stretched polypropylene (OPP) soft packaging film (obtained from Toyobo Co., Ltd., PYLENE P2102) to which the pre-processing fluid was previously applied in an amount of 3 g/m² with a bar coater No. 1 and then dried at 80 degrees C. for 2 minutes, to print a chart of whitely-voided Gothic typeface letters with the non-white ink and then form a solid image with the white ink. Then, the images were dried at 80 degrees C. for 2 minutes.

Readability of the letters in the obtained image was judged with the naked eyes, and visually evaluated according to the criteria described below. The ratings B and A are practically usable levels.

<Evaluation Criteria>

A: Gothic typeface of 3 pt was readable.

B: 3 pt was unreadable, but 4 pt was readable.

C: 4 pt was unreadable, but 5 pt was readable.

D: 5 pt was unreadable.

TABLE 4-1

| | Ex. 1 | Ex. 2 | Ex. 3 | Ex. 4 | Ex. 5 |
|---|---|---|---|---|---|
| Non-white ink | Non-white ink 1 | Non-white ink 2 | Non-white ink 3 | Non-white ink 4 | Non-white ink 5 |
| White ink | White ink 1 | White ink 2 | White ink 3 | White ink 4 | White ink 5 |
| Pre-processing fluid | Pre-processing | Pre-processing | Pre-processing | Pre-processing | Pre-processing |
| | fluid 1 | fluid 2 | fluid 3 | fluid 4 | fluid 5 |
| Cissing | A | A | A | B | B |
| White hiding ratio | A | A | A | A | B |
| Dischargeability | A | B | B | A | A |
| Bleeding | A | B | B | A | B |

TABLE 4-2

| | Ex. 6 | Ex. 7 | Ex. 8 | Ex. 9 | Ex. 10 |
|---|---|---|---|---|---|
| Non-white ink | Non-white ink 6 | Non-white ink 7 | Non-white ink 8 | Non-white ink 9 | Non-white ink 9 |
| White ink | White ink 6 | White ink 7 | White ink 8 | White ink 9 | White ink 9 |
| Pre-processing fluid | Pre-processing | Pre-processing | Pre-processing | Pre-processing | — |
| | fluid 6 | fluid 7 | fluid 8 | fluid 9 | |
| Cissing | A | A | A | B | B |
| White hiding ratio | B | B | B | A | B |
| Dischargeability | A | A | A | A | B |
| Bleeding | B | A | A | B | B |

TABLE 4-3

| | Ex. 11 | Ex. 12 | Ex. 13 | Comp. Ex. 1 | Comp. Ex. 2 |
|---|---|---|---|---|---|
| Non-white ink | Non-white ink 10 | Non-white ink 1 | Non-white ink 1 | Non-white ink 11 | Non-white ink 1 |
| White ink | White ink 10 | White ink 12 | White ink 13 | White ink 1 | White ink 11 |
| Pre-processing fluid | Pre-processing | Pre-processing | Pre-processing | Pre-processing | Pre-processing |
| | fluid 9 | fluid 1 | fluid 1 | fluid 1 | fluid 2 |
| Cissing | B | A | A | C | D |
| White hiding ratio | B | A | A | C | D |
| Dischargeability | B | A | A | B | B |
| Bleeding | B | A | A | B | B |

Aspects of the present disclosure are, for example, as follows.

<1> An ink set including:

a non-white ink, which contains water, a coloring material, an organic solvent, and an acetylene glycol compound; and a white ink, which contains water, a coloring material, an organic solvent, and a compound represented by General formula (1) below:

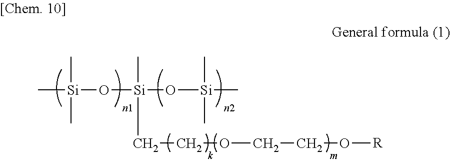

where R represents a hydrogen atom or a methyl group, n₁ and n₂ represent integers of from 1 through 7, k represents an integer of from 0 through 5, and m represents an integer of from 1 through 20.

<2> The ink set according to <1>,

wherein the acetylene glycol compound contains an acetylene glycol compound represented by General formula (2) below,

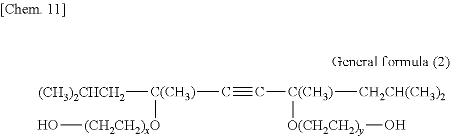

where x and y represent integers of 0 or greater and x+y is an integer of from 0 through 3.

<3> The ink set according to <1> or <2>,

wherein the non-white ink further contains dialkylsulfosuccinic acid or a salt thereof.

<4> The ink set according to any one of <1> to <3>,

wherein the compound represented by General formula (1) includes a compound represented by General formula (1-1) below:

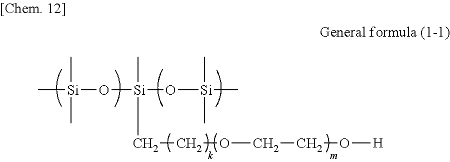

where k represents an integer of from 0 through 5 and m represents an integer of from 1 through 20.

<5> The ink set according to any one of <1> to <4>, wherein a static surface tension of the white ink is 30 mN/m or lower, and a dynamic surface tension of the white ink at a surface lifetime of 15 msec according to maximum bubble pressure method is 34 mN/m or lower.

<6> A printing method including:

applying the non-white ink of the ink set according to any one of <1> to <5> to a print medium; and

applying the white ink of the ink set according to any one of <1> to <5>.

<7> The printing method according to <6>,

wherein the applying the non-white ink is followed by the applying the white ink.

<8> The printing method according to <6> or <7>,

wherein the printing method includes no drying between the applying the non-white ink and the applying the white ink.

<9> The printing method according to any one of <6> to <8>, further including reforming a surface of the print medium.

<10> The printing method according to any one of <6> to <9>, further including applying a processing fluid to the print medium, the processing fluid containing a polyvalent metal salt.

<11> The printing method according to any one of <6> to <10>, wherein the print medium is a non-absorbable soft packaging film.

<12> A printing apparatus including:

the non-white ink of the ink set according to any one of <1> to;<5>; the white ink of the ink set according to any one of <1> to;<5>;

a print medium, which is a non-absorbable soft packaging film;

a non-white ink applying unit configured to apply the non-white ink; and a white ink applying unit configured to apply the white ink.

<13> A printing set including:

a non-white ink, which contains water, a coloring material, an organic solvent, and an acetylene glycol compound;

a white ink, which contains water, a coloring material, an organic solvent, and a compound represented by General formula (1) below; and

a processing fluid, which contains water and a polyvalent metal salt,

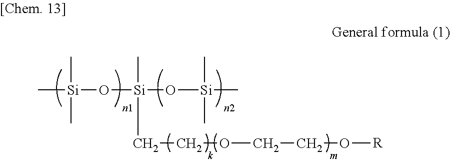

where R represents a hydrogen atom or a methyl group, n₁ and n₂ represent integers of from 1 through 7, k represents an integer of from 0 through 5, and m represents an integer of from 1 through 20.

<14> A non-white ink comprising:
water;
a coloring material;
an organic solvent; and
an acetylene glycol compound,

wherein the non-white ink is used in the printing apparatus according to <12>.

<15> A white ink comprising:
water;
a coloring material;
an organic solvent; and
a compound represented by General formula (1) below:

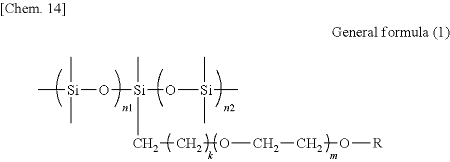

where R represents a hydrogen atom or a methyl group, n₁ and n₂ represent integers of from 1 through 7, k represents an integer of from 0 through 5, and m represents an integer of from 1 through 20,

wherein the white ink is used in the printing apparatus according to <12>.

The ink set according to any one of <1> to <5>, the printing method according to any one of <6> to <11>, the printing apparatus according to <12>, the printing set according to <13>, the non-white ink according to <14>, and the white ink according to <15> can solve the various problems in the related art and achieve the object of the present disclosure.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

This patent application is based on and claims priority to Japanese Patent Application Nos. 2020-092269 and 2021-001908, filed on May 27, 2020 and Jan. 8, 2021, respectively, in the Japan Patent Office, the entire disclosure of each of which is hereby incorporated by reference herein.

### REFERENCE SIGNS LIST

400: Image forming apparatus
401: Exterior of image forming apparatus
401c: Cover of image forming apparatus
404: Cartridge holder
410: Main tank
410k, 410c, 410m, 410y: Main tank for each color of black (K), cyan (C), magenta (M), and yellow (Y)
411: Ink container
413: Ink discharging outlet
414: Plastic housing unit
420: Mechanical unit
434: Discharging head
436: Supplying tube
1: Print medium
2: Processing fluid applying device
3: White ink discharging head
4: Non-white ink discharging head
7: Conveyor belt
100: Printing apparatus

1. An ink set, comprising:
a non-white ink, which comprises water, a coloring material, an organic solvent, and an acetylene glycol compound; and
a white ink, which comprises water, a coloring material, an organic solvent, and a compound represented by General formula (1) below: 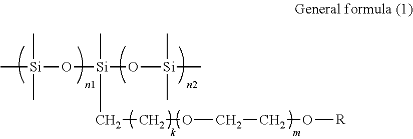
where R represents a hydrogen atom or a methyl group, n₁ and n₂ represent integers of from 1 through 7, k represents an integer of from 0 through 5, and n₁ represents an integer of from 1 through 20.

2. The ink set according to claim 1, wherein the acetylene glycol compound comprises an acetylene glycol compound represented by General formula (2) below: 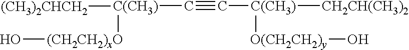
where x and y represent integers of 0 or greater and x+y is an integer of from 0 through 3.

3. The ink set according to claim 1, wherein the non-white ink further comprises dialkylsulfosuccinic acid or a salt thereof.

4. The ink set according to claim 1, wherein the compound represented by General formula (1) comprises a compound represented by General formula (1-1) below: 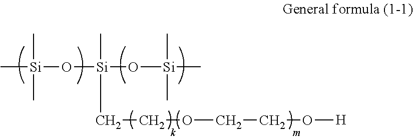
where k represents an integer of from 0 through 5 and m represents an integer of from 1 through 20.

5. The ink set according to claim 1, wherein a static surface tension of the white ink is 30 mN/m or lower, and a dynamic surface tension of the white ink at a surface lifetime of 15 msec according to a maximum bubble pressure method is 34 mN/m or lower.

6. A method of printing with the ink set of claim 1, comprising:
applying the non-white ink to a print medium; and
applying the white ink.

7. The method according to claim 6, wherein the applying the non-white ink is followed by the applying the white ink.

8. The method according to claim 6, wherein the method comprises no drying between the applying the non-white ink and the applying the white ink.

9. The method according to claim 6, further comprising:
reforming a surface of the print medium.

10. The printing method according to claim 6, further comprising:
applying a processing fluid to the print medium, the processing fluid comprising a polyvalent metal salt.

11. The method according to claim 6, wherein the print medium is a non-absorbable soft packaging film.

12. A printing apparatus, comprising:
the ink set according to claim 1, comprising the non-white ink and the white ink;
a print medium, which is a non-absorbable soft packaging film;
a non-white ink applying unit configured to apply the non-white ink; and
a white ink applying unit configured to apply the white ink.

13. A printing set, comprising:
a non-white ink, which comprises water, a coloring material, an organic solvent, and an acetylene glycol compound;
a white ink, which comprises water, a coloring material, an organic solvent, and a compound represented by General formula (1) below; and
a processing fluid, which comprises water and a polyvalent metal salt, 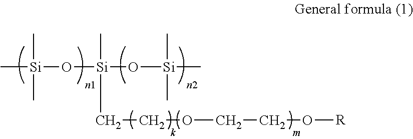
where R represents a hydrogen atom or a methyl group, n₁ and n₂ represent integers of from 1 through 7, k represents an integer of from 0 through 5, and in represents an integer of from 1 through 20.

14. A non-white ink, comprising:
water;
a coloring material;
an organic solvent; and
an acetylene glycol compound,
wherein the non-white ink is suitable for printing with the printing apparatus according to claim 12.

15. A white ink, comprising:
water;
a coloring material;
an organic solvent; and
a compound represented by General formula (1) below: 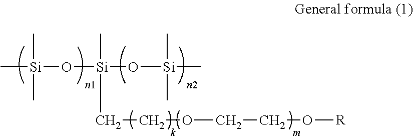
where R represents a hydrogen atom or a methyl group, n₁ and n₂ represent integers of front 1 through 7, k represents an integer of from 0 through 5, and in represents an integer of from 1 through 20,
wherein the white ink is suitable for printing with the printing apparatus according to claim 12.
